(19) United States
(12) Patent Application Publication
(10) Pub. No.: US 2026/0309887 A1
(43) Pub. Date: Oct. 8, 2026

(54) LOW-FREQUENCY STRAIN DATA RECORDED WITH DISTRIBUTED ACOUSTIC SENSING (DAS) FOR HYDRAULIC FRACTURING MONITORING

(71) Applicant: Schlumberger Technology Corporation, Sugar Land, TX (US)

(72) Inventors: Arkady Yurievich Segal, Houston, TX (US); Dmitry Sergeevich Kuznetsov, Sugar Land, TX (US); Roman Vladimirovich Korkin, Sugar Land, TX (US); Joel Herve Le Calvez, Sugar Land, TX (US)

(21) Appl. No.: 19/631,694

(22) Filed: Mar. 27, 2026

Related U.S. Application Data
(60) Provisional application No. 63/782,086, filed on Apr. 2, 2025.

(51) Int. Cl. G01V 1/50; E21B 43/267; E21B 47/00; E21B 49/00; G01V 1/22

(52) U.S. Cl. CPC G01V 1/50; E21B 43/267; E21B 47/00; E21B 49/00; G01V 1/226; E21B 2200/20

(57) ABSTRACT

A method for characterizing a hydraulic fracture includes acquiring surface data and downhole data. The method may also include formulating a model based upon the surface data and the downhole data to predict strain field propagation in a subsurface which contains the hydraulic fracture. The method may also include implementing an inversion method using the model to determine fracture parameters of the hydraulic fracture.

### CROSS-REFERENCE TO RELATED APPLICATIONS

This application claims priority to U.S. Provisional Patent Application No. 63/782,086, filed on Apr. 2, 2025, which is incorporated by reference.

### BACKGROUND

Hydraulic fracturing constitutes a well stimulation methodology extensively implemented in hydrocarbon extraction industries to enhance production efficiency from formations exhibiting low permeability characteristics. Hydraulic fracturing includes the high-pressure injection of fluid media into wellbore structures to induce fracture networks within target geological formations, thereby enhancing permeability parameters and facilitating hydrocarbon mobility.

Conventional operational protocols frequently employ multi-stage fracturing techniques, where sequential stimulation treatments are executed along horizontal wellbore trajectories to maximize reservoir contact surface area. Within such operational frameworks, a technical challenge designated as “FracHit” may manifest when newly initiated hydraulic fractures intersect previously stimulated zones or adjacent wellbore structures. FracHit phenomena are associated with production interference mechanisms, wellbore structural integrity compromise, and diminished recovery efficiencies, thereby representing an economic detriment.

Real-time monitoring of fracture propagation parameters has become useful for optimization of hydraulic fracturing treatments and mitigation of FracHit occurrences. Established monitoring methodologies include microseismic monitoring systems, tiltmeter arrays, and pressure monitoring protocols, each exhibiting inherent limitations regarding spatial resolution capabilities, sensitivity thresholds, or deployment constraints.

Distributed Acoustic Sensing (DAS) technology has emerged as a viable methodological approach for downhole monitoring applications. DAS implementation utilizes fiber optic cable assemblies to quantify strain variations along the entirety of the fiber length via analysis of backscattered light resultant from laser pulse transmission, effectively establishing numerous sensing points with high spatial and temporal resolution parameters. While DAS applications have centered on high-frequency acoustic events (e.g., >10 Hz), recent technological advancements have facilitated the measurement of low-frequency strain data (e.g., <10 Hz). The low-frequency components encompass information regarding quasi-static deformation characteristics of subsurface formations resultant from hydraulic fracturing operations.

What is needed is an improved system and method for performing hydraulic fracture monitoring using low-frequency strain data recorded with DAS.

### SUMMARY

A method for characterizing a hydraulic fracture is disclosed. The method includes acquiring surface data and downhole data. The method may also include formulating a model based upon the surface data and the downhole data to predict strain field propagation in a subsurface which contains the hydraulic fracture. The method may also include implementing an inversion method using the model to determine fracture parameters of the hydraulic fracture.

A computing system is also disclosed. The computing system includes one or more processors and a memory system. The memory system includes one or more non-transitory computer-readable media storing instructions that, when executed by at least one of the one or more processors, cause the computing system to perform operations. The operations include acquiring surface data during a hydraulic fracturing operation that is performed to produce a hydraulic fracture in a subsurface. The surface data is related to a slurry that is pumped into a well in the subsurface. The surface data includes a pressure of the slurry, a rate of slurry, and/or a concentration of a proppant in the slurry. The operations also include acquiring downhole data during the hydraulic fracturing operation. The downhole data includes distributed acoustic sensing (DAS) data. The DAS data includes strain data acquired from a fiber optic cable in a well. The operations also include formulating a model based upon the surface data and the downhole data to predict strain field propagation in the subsurface which contains the hydraulic fracture. The operations also include implementing an inversion method using the model to determine fracture parameters of the hydraulic fracture. The model implements the inversion method by comparing the surface data, the downhole data, and the strain field propagation. The fracture parameters include a height of the hydraulic fracture, a length of the hydraulic fracture, a width of the hydraulic fracture, a longitude of the hydraulic fracture, a latitude of the hydraulic fracture, a twist angle of the hydraulic fracture, and/or a stimulation efficiency. The operations also include estimating an orientation and/or dimensions of the hydraulic fracture based upon the fracture parameters.

A non-transitory computer-readable medium is also disclosed. The medium stores instructions that, when executed by one or more processors of a computing system, cause the computing system to perform operations. The operations include acquiring surface data during a hydraulic fracturing operation that is performed to produce a hydraulic fracture in a subsurface. The surface data is related to a slurry that is pumped into a well in the subsurface. The surface data includes a pressure of the slurry, a rate of slurry, and a concentration of a proppant in the slurry. The operations also include acquiring downhole data during the hydraulic fracturing operation. The downhole data includes distributed acoustic sensing (DAS) data. The DAS data includes strain data acquired from a fiber optic cable. The strain data has a frequency less than 10 hertz. The fiber optic cable is pumped into the well, coupled to a tubing in the well, or cemented behind a casing in the well. The well is a monitoring well or a treating well. The operations also include formulating a model based upon the surface data and the downhole data to predict strain field propagation in the subsurface which contains the hydraulic fracture. The hydraulic fracture is part of a network of natural fractures, hydraulically-induced fractures, and/or reactivated fractures. The operations also include implementing an inversion method using the model to determine fracture parameters of the hydraulic fracture. The model implements the inversion method by comparing the surface data, the downhole data, and the strain field propagation. The fracture parameters comprise a height of the hydraulic fracture, a length of the hydraulic fracture, a width of the hydraulic fracture, a longitude of the hydraulic fracture, a latitude of the hydraulic fracture, a twist angle of the hydraulic fracture, and a stimulation efficiency. The operations also include estimating an orientation and/or dimensions of the hydraulic fracture based upon the fracture parameters. The orientation and/or dimensions are estimated with quantified uncertainty metrics. The operations also include performing an action based upon and/or in response to the orientation and/or dimensions. The action comprises generating and/or transmitting a signal that recommends, instructs, or causes a physical action to occur related to the slurry.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion.

FIG. 1 is an illustration of fracture orientation parameterization, according to one or more examples of the disclosure.

FIG. 2 is an illustration of a first inversion method, according to one or more examples of the disclosure.

FIG. 3 is an illustration of a second inversion method, according to one or more examples of the disclosure.

FIG. 4 is an illustration of a third inversion method, according to one or more examples of the disclosure.

FIG. 5 illustrates a flowchart of a method for characterizing a hydraulic fracture utilizing distributed acoustic sensing (DAS) data, according to one or more examples of the disclosure.

FIG. 6 illustrates a schematic view of a wellsite with the hydraulic fracture formed in a subsurface, according to one or more examples of the disclosure.

### DETAILED DESCRIPTION

Illustrative examples of the subject matter claimed below will now be disclosed. In the interest of clarity, not all features of an actual implementation are described in this specification. It will be appreciated that in the development of any such actual implementation, numerous implementation-specific decisions may be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

Further, as used herein, the article “a” is intended to have its ordinary meaning in the patent arts, namely “one or more.” Herein, the term “about” when applied to a value generally means within the tolerance range of the equipment used to produce the value, or in some examples, means plus or minus 10%, or plus or minus 5%, or plus or minus 1%, unless otherwise expressly specified. Further, herein the term “substantially” as used herein means a majority, or almost all, or all, or an amount with a range of about 51% to about 100%, for example. Moreover, examples herein are intended to be illustrative only and are presented for discussion purposes and not by way of limitation.

The present disclosure delineates a comprehensive methodological framework for monitoring hydraulic fracturing operations utilizing fracture pumping data (e.g., with pressure, rate and proppant concentration), and a fracture growth model of a fracture simulator coupled with low-frequency strain data acquired via Distributed Acoustic Sensing (DAS) technology. The framework encompasses the development of a mathematical model characterizing strain propagation in media containing hydraulic fractures and the implementation of novel inversion methods (also referred to as workflows) to determine fracture parameters from measured DAS data, the surface data, and the fracture simulator model.

The methodological process initiates with the formulation of a forward model that predicts strain field distributions surrounding hydraulic fractures with defined dimensional and orientational parameters. The model incorporates the mechanical properties of reservoir lithology and the spatial relationship between hydraulic fracture geometry and fiber optic sensing apparatus placement.

While the mathematical modeling of strain propagation constitutes a component, the present disclosure also includes specialized inversion methods that determine fracture parameters from observed DAS data. The inversion methods may be specifically engineered to overcome the fact the inverse problem is inherently ill-posed, because multiple fracture parameter configurations may produce substantially identical strain patterns at observation points.

The present disclosure implements inversion methods that substantially reduce parameter ambiguity through advanced optimization algorithms and uncertainty quantification methodologies, based on pressure, rate, proppant concentration data, fracture model or simulator and a-priori known geological data. The methods enable reliable estimation of hydraulic fracture's geometrical and physical properties (e.g., constrained by the pumping and geological data) in the presence of signal noise and incomplete data acquisition scenarios.

Through the provision of robust estimations regarding fracture geometry and propagation characteristics, the disclosed method enables operators to implement informed decision-making protocols during hydraulic fracturing operations, optimize treatment parameters, and minimize Frac Hit risk factors, thereby enhancing production outcomes and operational efficiency metrics. The method includes a specific inversion method that reduces the inversion ambiguity.

Several different approaches may be used to resolve the problem of the fracture geometry reconstruction. The approaches may include a step-by-step inversion algorithm, a particle filter-based inversion, and/or a gradient-descent-based inversion directly over the depth-time dimensions simultaneously with PKN-physics regularization. The approaches may be used separately at different conditions (e.g., sequential or post job analysis) or as a combination for improved robustness and accuracy. In this sense, the methods may provide same results (within expected uncertainty) to ensure the predictability.

### Measurement Methodology

As discussed above, a fiber-optic cable with a high-frequency sample rate and short gauge length may be used. Depending on the application, the cable may or may not be covered with protective layers. The cable can be either pumped into the monitoring well or cemented behind the casing. If placing it in the monitoring well is not feasible, it can instead be deployed in the treating well-either pumped in or cemented behind the casing.

However, using the cable in the treatment well has some drawbacks. If pumped in, it may be eroded by proppant flow. Additionally, placing the cable in the treatment well (whether inside or outside the casing) may reduce the accuracy of fracture network geometry predictions compared to placement in the monitoring well. If pumped into the treatment well, the cable may be covered with protective layers to ensure its survivability during fracturing operations.

Despite these limitations, deploying the cable inside the treatment well enables the quantification of flow rates through individual clusters. This data can then serve as input for a fracture simulator. Without direct flow rate measurements for each cluster, the simulator relies on assumed rate distributions, which may not always be accurate.

### The Disclosed Methodological Framework: Process Delineation

The present disclosure introduces a comprehensive process for hydraulic fracture monitoring utilizing low-frequency DAS data acquisition:

### Step 1: Mathematical Modeling of Strain Propagation

The process initiates with the development of a forward model predicting strain field distributions surrounding hydraulic fractures. The model may incorporate:
1. Linear elastic fracture mechanics principles and governing equations
2. Poro-elastic effect quantification within reservoir media
3. Fluid flow dynamics characterization within fracture networks
4. Coupling mechanisms between fracture propagation and rock deformation phenomena
5. Fiber optic sensing principles governing DAS measurement acquisition

As a simple practical option, the method may use an analytical solution for a static strain field induced by a fracture of a given shape in the surrounding formation, treating the formation as elastic, homogeneous, and isotropic as a first approximation. A fracture may be represented by either thin parallelepiped or an ellipsoid of an arbitrary orientation in space. For such simplified representations of fracture geometry, analytical solutions for strain field are available. For a few fractures originating from a single stage, contributions of individual fractures may be added to obtain the total strain field. If the optical fiber is tightly coupled to the monitoring well and to the rock, it captures the projection of the local strain field onto the well. This may produce a “forward model” that maps parameters of fractures such as length, height, width, orientation to the strain field at the monitoring well. If the optical fiber is loosely coupled (e.g. if it is a part of a wireline cable or a disposable cable lying on the monitoring well bottom), the fiber strain response may differ from the surrounding rock, and a “transfer function” being a model of relating the rock strain to the cable may be incorporated. In another embodiment, the method can start with assuming the transfer function to be a constant from 0 to 1.

One distinction between the method described herein and conventional methods is that the DAS data cannot predict fracture geometry. This procedure has essential ambiguity (i.e., different fracture geometries may cause the same strain). The current approach suggests the service, which has at least three components: (a) surface data on pressure, rate, and proppant concentration, (b) fracture model or fracture simulator, and (c) distributed acoustic sensing data. This relationship constitutes a component for the subsequent inversion process implementation. Also, the method described herein assumes using available geological data to constrain fracture parameters (e.g., fracture height, range of longitude, and latitude angles and possible fracture twist). The additional embodiment suggests using Bayesian filters or other dynamic algorithms to incorporate fracture parameters at previous time moments and their uncertainties for the more robust prediction of the fracture parameters at the future steps.

### Step 2: DAS Data Acquisition and Processing Protocols

During hydraulic fracturing operations, low-frequency strain data may be acquired utilizing fiber optic cables deployed in observation wells or within the treatment well structure. The acquired DAS data undergoes preprocessing protocols to:
1. Isolate the low-frequency components (e.g., <10 Hz) through appropriate filtering methodologies
2. Implement noise and artifact removal algorithms
3. Apply signal enhancement techniques in accordance with signal-to-noise ratio optimization
4. Establish baseline measurement parameters for reference comparison

These procedures may be managed by the provider of the DAS equipment.

### Step 3: Inversion Process Implementation

The inversion process may determine fracture parameters from observed DAS data. In particular, the stress-strain state may be represented by a second rank symmetric tensor that has six independent components. However, the cable uses one of these components (e.g., linear combination), though at multiple points along the cable. As a result, there may be multiple possible solutions that correspond to the same stress-strain results. The approaches described below allow the method to reduce, or even eliminate, these uncertainties.

Three inversion methods are proposed. In the description, “inversion” is differentiated from “optimization” as being the full method aimed at determining true parameters, while “optimization” is a process of tuning the model parameters to match the observed data. Due to inversion ambiguity, many optimizations can provide good match, while some of them are close to the true solution. A proper inversion procedure may use multiple optimization runs to generate a proper solution being sufficiently close to the true one.

An optimization method may include:
1. Initialization of fracture model parameters based on prior geological knowledge
2. Prediction of strain patterns utilizing the forward model
3. Comparative analysis between predicted and observed strain measurements
4. Parameter updating utilizing specialized inversion techniques
5. Iterative processing until predetermined convergence criteria are satisfied

The optimization algorithms may be or include Gradient Descent, Stochastic Conjugated Gradients, Nelder-Mead, L-BFGS-G, COBYLA, etc.

Several fracture parameters are responsible for its orientation. One of the methods to define fracture orientation is:
1. Define a ray of normal direction N to the fracture plane
2. Spot a point N_g on a celestial sphere intersected by N
3. Determine N_g's longitude φ and latitude θ
4. Rotate the fracture around N by an angle α (twist)

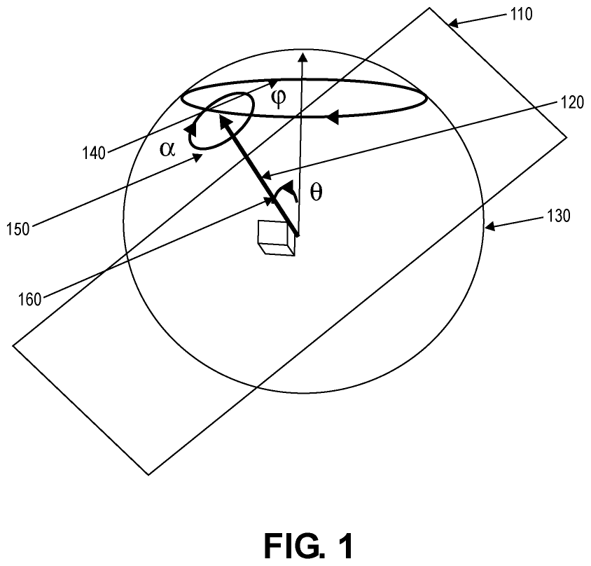

This way, fracture orientation is determined by 3 angles Ω=(φ, θ, ε) naturally constrained to [0,180), [0,180) and [0,90) degrees, respectively. FIG. 1 illustrates a fracture orientation parameterization, according to one or more examples of the disclosure. The fracture orientation parameterization may include a fracture rectangle 110, a normal vector N to the fracture 120, a celestial sphere 130, a rotation parameterized by longitude φ 140, a rotation parameterized by twist α 150, and a rotation parameterized by latitude θ 160.

### Method 1: Global Orientation Search

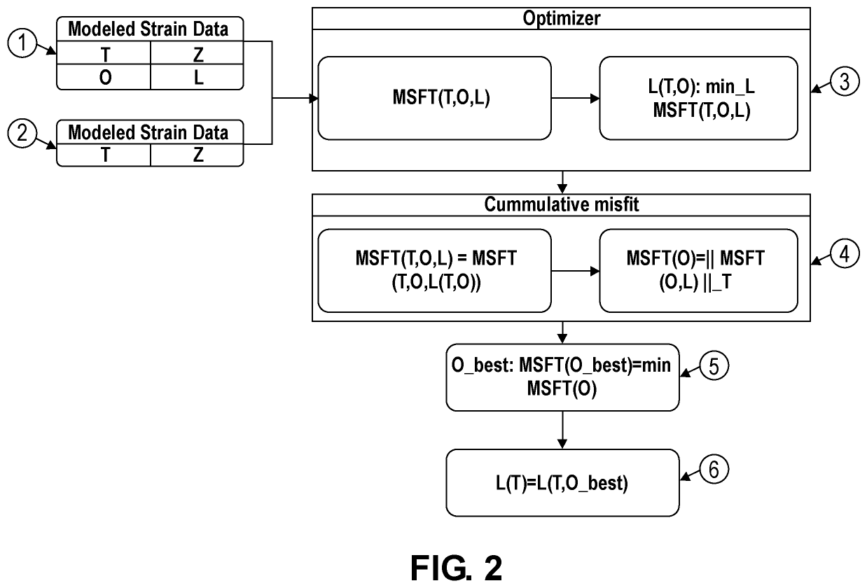

FIG. 2 illustrates a schematic view of a first inversion method, according to one or more examples of the disclosure. The method is efficient when the fracture is a planar feature with a constant orientation. A misfit M(t) is defined as a mean squared error (MSE) at given time moment t, where MSE is calculated as the mean (average) of the squared differences between strain predictions and actual observations. It depends on the fracture parameters and, in particular, on the angles defining fracture orientation,

$$m ( t ) = M ( Ω , t , X ( t ) ) \qquad ( 1 )$$

where X(t) stand for fracture length, height and width. Here, the length and width may be constrained by the surface data, and the flow model or simulator. The optimization problem may be solved for every t thus defining X(t|Ω) and the “best misfits”

$$M ( Ω ) = \int d t M ( Ω , t , X ( t \vert Ω ) ) \qquad ( 2 )$$

A discrete subset O of fracture orientations may be characterized by 3 parameters, e.g. Ω=(φ, θ, ε). In particular, the subset can be defined to be a direct product of uniform grids spanning segments of φ, θ, ε. In case a-priori information about fracture orientation is available, the segments may be narrow, otherwise, they may span the full range. Accordingly, to each element of O, the method may associate certain fracture orientation and defines M(Ω). By full grid search over O, the method may find minimum of M(Ω) and thus the best orientation Ω_{best}:

$$M ( {Ω}_{best} ) = min M ( Ω ) \qquad ( 3 )$$

For Ω_{best}, fracture evolution histories may be given by already calculated:

$$x ( t ) = X ( t \vert {Ω}_{best} ) \qquad ( 4 )$$

This method efficiency is based on the stability of fracture orientation over time. The true orientation's solution tendency to win over other solutions increases with passage of time—its leadership in minimizing the misfit integral grows with time since errors of nontrue solutions also accumulate with time.

In FIG. 2, the modules represent data processing steps. The variables T, Z, O, L denote dependence on time T, fiber length Z, fracture orientation O, and fracture dimensions (length, height, width) denoted L. The method may include receiving input data. The input data may include modeled strain data 210, which may depend on time T, fiber length Z, fracture orientation O, and/or fracture dimensions L. The input data may also or instead include measured strain data 220, which may depend on time T and/or fiber length Z.

The method may then perform fracture dimension optimization 230 to ensure minimization of misfit MSFT w.r.t. variations of L, at arbitrary but fixed time T and orientation O. The method may then determine a cumulative misfit MSFT(O) 240, which may be a time integral of misfits MSFT(T,O,L) evaluated at optimized dimensions L(O,T). The method may then determine a (e.g., best) fracture orientation O 250 by best-minimizing the misfit MSFT(O). The method may then determine the inversion problem solution 260 as L(T,O) at O=O_best.

### Method 2: Multi-Seed Solution Clustering

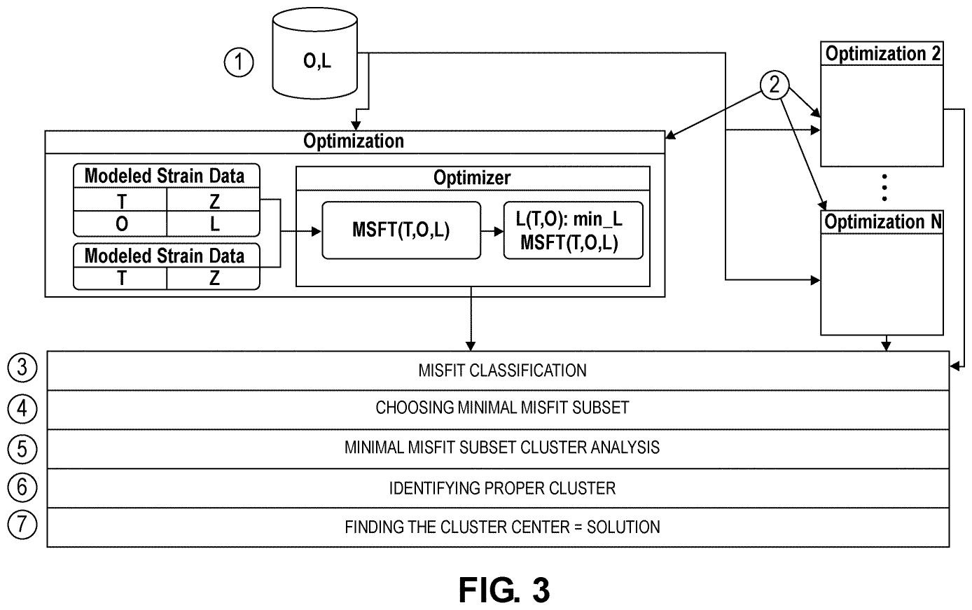

FIG. 3 illustrates a schematic view of a second inversion method, according to one or more examples of the disclosure. This method is more computationally heavy, and it can be applied when the first one does not provide satisfactory results (e.g., when the fracture propagation is essentially non-planar).

For each time moment T, an ensemble of initial guess configurations, or “seeds”, of fracture parameters may be defined, including orientation O and fracture sizes L,

$${S}_{i} = ( {O}_{i} , {L}_{i} ) , i = 1 , … , N \qquad ( 5 )$$

The set Sᵢ can be generated stochastically based on a pre-defined distribution (e.g. uniform distribution within a range specified by a fracture model or simulator and the surface data):

$${Q}_{i , min} \leq {S}_{i} \leq {Q}_{i , max} \qquad ( 6 )$$

For each seed, an optimization algorithm may be run to determine the (e.g., best) match to the field data by minimizing the misfit between the measured and the modeled data:

$$MSFT ( Q , T ) = \frac{1}{{n}_{z}} {\sum }_{Z} {( {S}_{m o d e l e d} ( T , Z \vert Q ) - {S}_{m e a s u r e d} ( Z , T ) )}^{2} , \qquad ( 7 )$$

where n_{z} is a number of points in Z, and

$$Q = ( O , L ) . \qquad ( 8 )$$

In the optimization algorithm, the variable Q may be provided such that the misfit is small, and the match to the field data is good. However, it does not guarantee Q is close to the ground truth solution. For each seed Sᵢ, the optimization result may be referred to as “a fruit” and denoted Fᵢ. Each fruit is thus a combination of fracture orientation and sizes ensuring a good match to the measured strain data. The misfit value corresponding to the fruit Fᵢ may be denoted Mᵢ:

$${M}_{i} = {\sum }_{Z} {( {S}_{m o d e l e d} ( T , Z \vert {F}_{i} ) - {S}_{m e a s u red} ( Z , T ) )}^{2} , \qquad ( 9 )$$

The distribution of Mᵢ may be analyzed, and those occupying the lowest level may be extracted. They correspond to “the best fruits” in terms of matching to the measured data. It extracts a subset B of all fruits. The fruits of B are points in a multi-dimensional space with coordinates representing fracture orientation and dimensions. There may be 8 parameters: 3 angles of fracture orientation, 1 for fracture width, 2 parameters for the fracture rectangle dimensions (length, height), and 2 for a fracture center offset with respect to the origin within the fracture plane.

The next step to do is a clustering analysis on the cloud of fruits B. Cluster analysis represents a technique in data mining and statistical analysis, enabling the grouping of objects such that items within a cluster share greater similarity with each other than with those in different clusters. This unsupervised learning method organizes data into meaningful structures without predefined labels, making it useful across disciplines including market segmentation, image processing, and anomaly detection. Among the various clustering approaches, distance-based methods have emerged as effective due to their intuitive interpretation and computational efficiency. These methods quantify the similarity between data points using distance metrics such as Euclidean, Manhattan, or Mahalanobis distance, allowing for the formation of clusters where points are spatially proximate in the feature space.

By employing algorithms that iteratively minimize the distance between points within clusters while maximizing the separation between different clusters, these methods create an optimal partitioning that reveals intrinsic patterns and relationships within complex datasets. In application to fracture parameters, a natural distance between rectangles may be introduced. One such natural distance is Hausdorff distance, which treats each fracture as a set of 4 points being rectangle vertices. The Hausdorff distance between two rectangles A and B is the maximum distance from any point in either rectangle to the closest point in the other rectangle. It is invariant with regard to translations and rotations and satisfies the axioms of distance, including positivity and triangle identity, and is thus a good measure of how one rectangle differs from another one. The algorithm described herein a nearest neighbor classifier based on Hausdorff distance to break down B into clusters B=∪B_{α}. The size S_{α} of each cluster B_{α} can also be defined based on Hausdorff distance, and the size of its core can be considered as a natural error bar for the inversion problem solution. Cluster centers F_{α} can be defined e.g. as elements whose average distance to the other cluster elements is minimal.

With enough seeds ranging from N=10³ to N=10⁴, the clustering procedure is robust in the sense that cluster sizes and centers are practically independent of the initial distribution of seeds. The candidate solutions are cluster centers. One may have 2 to 10 clusters, and correspondingly there are 2 to 10 solution candidates. The method looks for the most populated cluster and identifies the true solution as its cluster center. This approach has shown its effectiveness on simulated data with added noise. The process is repeated over time, which provides a dynamical solution for the fracture dimensions and orientation.

In case the fracture orientation is stable over time, the dynamical solution represents a planar fracture propagation. However, it may turn out the true solution belongs to a less populated cluster. In that case, additional considerations may be invoked in order to choose a proper cluster.

These additional considerations may be of a common-sense nature, as one cluster represents a fracture consistent with basic fluid balance and geomechanics.

As the inversion process cycles over time, clusters may be either stable in the sense they slowly evolve with time, in a good case, or percolate and disappear in the worst case. Thus, quality assurance procedures are to be in place to monitor cluster stability. One such quality assurance measure may include using a generalized Particle Filter technique. In the case the main cluster is stable, its center dynamics represents the solution to inversion problem.

Other methods of analysis of the cloud of fruits are possible. In particular, a probability density estimator may find the location of the maximum probability and assign it as a solution. This approach has been proven feasible in synthetic studies with added noise.

As shown in FIG. 3, the method may include receiving input data. The input data may include a pull of seeds (e.g., initial guesses) 210. One or more optimizers 320 may then run optimization processes associated with each seed. The method may then perform classification 330 of final misfits pertaining to seeds. The method may then identify 340 cases with the lowest misfit. The method may then cluster 350 the lowest misfit solutions (e.g., with a Hausdorff distance-based nearest neighbor algorithm). The method may then identify 360 a proper cluster based on basic physical analysis such as volume balance and realistic dimensions. The method may then set 370 the solution to be the cluster center.

These specialized inversion methods address the fact that the inverse problem is ill-posed and do so through advanced techniques incorporating geological constraints, prior information, and uncertainty quantification methodologies. In contrast to conventional approaches, the methods provide reliable fracture parameter estimations with quantified uncertainty metrics.

### Method 3

This approach integrates a priori information known about a well and, in particular, a fracture. First, one or more fractures may be created during a single hydraulic fracturing operation. The well completion method may provide general information about the process. Here, an example based on the plug-and-perf completion method is described, though other completion methods may also be incorporated within a similar approach.

A single-stage operation in a plug-and-perf multistage hydraulic fracturing job assumes the perforation of several clusters (N), which may or may not result in the formation of N individual fractures. Assuming that the N fractures are formed (the absence of one mathematically implies a small or zero fracture volume), the algorithm starts with the simultaneous growth of N fractures from their known formation centers (i.e., cluster centers).

Within the same stage, the formation can, in most cases, be considered (almost) uniform, resulting in the same longitudinal angle (φ) and the same top and bottom heights. If no specific data about the formation is available, the latitude and twist angles may be fixed to describe a vertical fracture with zero twist or, at the very least, constrained within predefined limits.

Second, fracture growth is a physical process governed by natural physical constraints based on fracture propagation models. There are multiple modern fracturing simulators, such as Kinetix™ (SLB) and GOHFER™ (Halliburton), which provide hydraulic fracturing models for given formation parameters. For simplicity, this approach uses a basic analytical model (PKN). However, other models, such as KGD or more complex P3D, Planar 3D software-based models, can be easily incorporated within the same methodology.

This method allows for the pre-calculation of the relationship between fracture volume, length, and width at different time stages, depending on the type of injected fluid and the injection rate. For simplicity, a leak-off-dominated regime may be considered, which occurs at later times. These times are of interest because strain measurements become meaningful when the fracture has reached a sufficient length and width.

The fracture length grows as the square root of time, while width follows a power law with an exponent of ⅛:

$$L \sim {t}^{\frac{1}{2}} , w \sim {t}^{\frac{1}{8}}$$

This implies the following logarithmic relationship:

$$log L \sim 4 log w$$

For a given fracture height (e.g., obtained from geological data), these parameters serve as the initial model-based estimates.

Third, the suggested method determines dynamic fracture parameters. Bayesian filters such as the Kalman filter, the particle filter, or more advanced combinations (e.g., Multiparticle Kalman Filter) may be applied. The Kalman filter operates by incrementally updating the fracture length and width for the N fractures assuming, for example, uniform growth based on the previous step values (which may not be the same). In this approach, the initial values of the fractures lengths and widths may be determined as zero, the stimulation efficiency parameter pre-defined at some value (fit for given formation/basin). Also, the model, measurement, and process covariance matrices may be determined. Again, these values may be based on prior information specific for the given job. For example, the fiberoptic measurements results may be known from the historical jobs or estimated from the noise level along the cable.

A GPU-accelerated particle filter implementation maintains an ensemble of N_p particles, each representing a complete fracture state (e.g., length, width, height, orientation angle φ, efficiency η). Weights may be updated in log-space for numerical stability. Systematic resampling may be triggered when the effective particle falls below some threshold (e.g., 25%) of the total particle count, preventing degeneracy.

Then, these parameters values may be dynamically updated. At each step, the individual fracture volume increases as (assumingly uniform increase of all fractures volumes):

$$δ {V}_{i} = η \frac{Q δ t}{N}$$

where Q is the total slurry rate, N is the number of growing fractures (clusters), and η is the stimulation efficiency at a given time. The corresponding changes in length and width are:

$$δ {L}_{i} = ( 4 / 5 ) ( {L}_{i} * \frac{δ {V}_{i}}{{V}_{i}} )$$

$$δ {w}_{i} = ( 4 / 5 ) ( {w}_{i} * \frac{δ {V}_{i}}{{V}_{i}} )$$

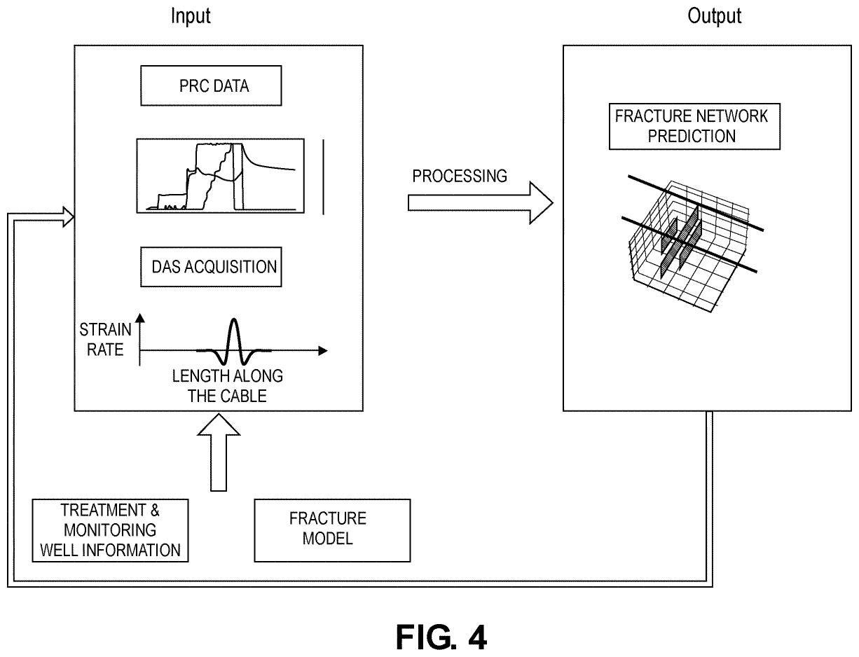

Note, at the update stage, the true increase in width and length is corrected based on measurement results, so that the volume of fractures in the fracture network may differ from one another. During the update step, the measured data along the fiber-optic cable are compared with predicted values based on the updated lengths and widths. Based on these discrepancies, the fracture parameters (Lᵢ, wᵢ, Vᵢ) and the new stimulation efficiency are refined. FIG. 4 illustrates a schematic view of a third inversion method, according to one or more examples of the disclosure. The data at time step t may be used as input. This may be combined with PRC and DAS data at the next time (t+1) to generate an output (fracture network) at the time t+1.

### Method 4

The same algorithm as in Method 3 provides more robust and less ambiguous results if there are two or more monitoring wells with the cable. In this situation, the lower values of the fracture parameters uncertainty allow faster algorithm convergence to the true data.

### Method 5

The joint spatio-temporal gradient descent workflow operates on the full time-depth data volume simultaneously, rather than processing time steps sequentially. The fracture parameters—lengths L(t, i), widths w(t, i), height h(t), and orientation angles φ(i)—may be treated as differentiable variables and optimized jointly using gradient-based methods (e.g. RMSprop/Adam). Two regularization terms constrain the solution: (a) a temporal smoothness penalty on consecutive parameter values, discouraging physically implausible abrupt changes; (b) a PKN-physics-consistency penalty enforcing the theoretical scaling L~t\hat{ }(½), w~t\hat{ }(⅛). Bounded physical domains may be enforced via sigmoid or other constrained reparameterization. This approach may be complementary to sequential Bayesian methods: it is better-suited for post-treatment batch analysis and provides a high-quality initialization for Method 3 particle filter runs, though, with minimal modifications, may be used for real time data processing.

### Step 4: Real-Time Monitoring and Decision Support Framework

The inversion results provide continuous estimation of fracture dimensional and orientational parameters throughout the treatment process. This information enables operators to:
1. Detect potential Frac Hit occurrences prior to manifestation.
2. Implement adjustment protocols for pumping schedules to control fracture growth parameters.
3. Optimize stage spacing and perforation cluster design specifications.
4. Verify proppant placement effectiveness.
5. Enhance overall field development planning methodologies.

### Field Implementation and Validation Procedures

The disclosed methodological framework has undergone testing procedures in multiple unconventional reservoir environments with pre-existing fiber optic installations. Field validation studies demonstrate that this approach provides fracture dimension estimation with enhanced confidence parameters compared to traditional monitoring techniques.

The methodology can be implemented utilizing existing computational resources at well sites, with processing time requirements compatible with real-time decision-making protocols during hydraulic fracturing operations. Integration with existing fracture simulation software platforms and visualization tools provides a seamless method implementation for operators.

### Method 6

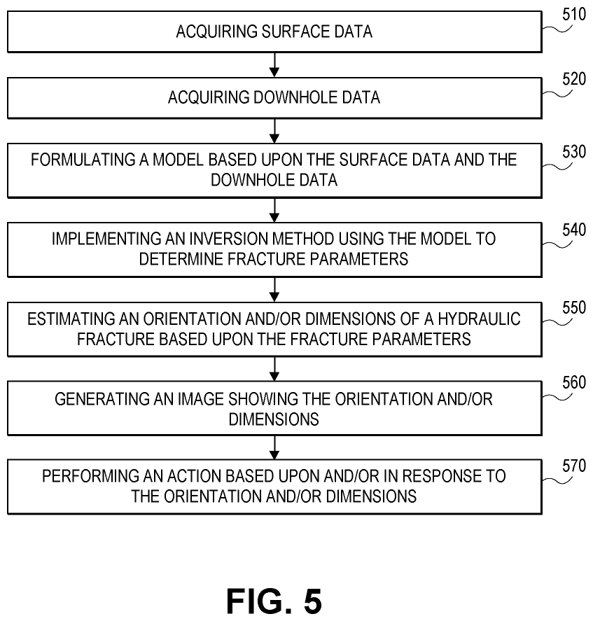

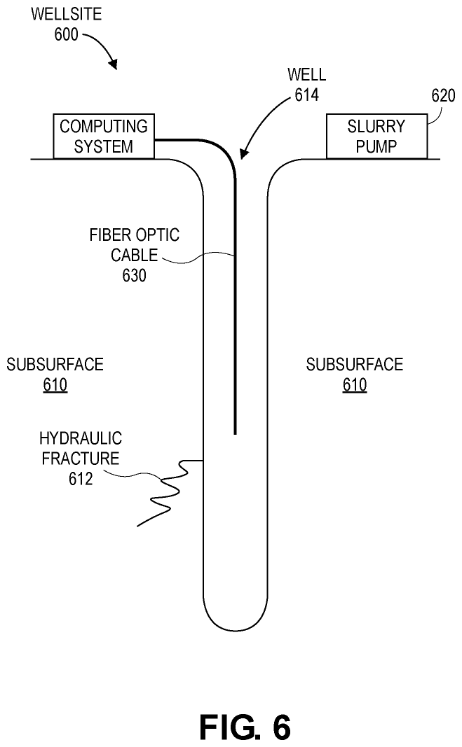

FIG. 5 illustrates a flowchart of a method 500 for characterizing a hydraulic fracture (e.g., utilizing DAS data), according to one or more examples of the disclosure. An illustrative order of the method 500 is provided below; however, one or more portions of the method 500 may be performed in a different order, simultaneously, repeated, or omitted. At least a portion of the method 500 may be performed using a computing system. FIG. 6 illustrates a schematic view of a wellsite 600 with the hydraulic fracture 612 formed in a subsurface 610, according to one or more examples of the disclosure.

The method 500 may include acquiring surface data, as at 510. The surface data may be acquired during a hydraulic fracturing operation that is performed to produce the hydraulic fracture 612 in the subsurface 610. The surface data may be related to a slurry 620 that is pumped into a well 614 in the subsurface 610. The surface data may include a pressure of the slurry 620, a rate of slurry 620, and/or a concentration of a proppant in the slurry 620.

The method 500 may also include acquiring downhole data, as at 520. The downhole data may be acquired during the hydraulic fracturing operation. The downhole data may include DAS data. The DAS data may include strain data acquired from a fiber optic cable 630. The strain data may have a frequency less than a low frequency threshold (e.g., 10 Hz). The fiber optic cable 630 may be pumped into the well 614, coupled to a tubing in the well 614, or cemented behind a casing in the well 614. The well 614 may be a monitoring well or a treating well.

The method 500 may also include formulating (e.g., generating or training) a model based upon the surface data and the downhole data, as at 530. The model may be formulated to predict strain field propagation in the subsurface 610 (which contains the hydraulic fracture 612). The hydraulic fracture 612 may be part of a network of natural fractures, hydraulically-induced fractures, and/or reactivated fractures. The model may incorporate linear elastic fracture mechanics governing equations. The model may also or instead incorporate poroelastic effect quantification within reservoir media. The model may also or instead incorporate fluid flow dynamics characterization within fracture networks. The model may also or instead incorporate coupling mechanisms between fracture propagation and rock deformation phenomena.

The method 500 may also include implementing an inversion method using the model to determine fracture parameters, as at 540. The model may implement the inversion method by comparing the surface data, the downhole data, and/or the strain field propagation. The fracture parameters may include a height of the hydraulic fracture 612, a length of the hydraulic fracture 612, a width of the hydraulic fracture 612, a longitude of the hydraulic fracture 612, a latitude of the hydraulic fracture 612, a twist angle of the hydraulic fracture 612, a stimulation efficiency, or a combination thereof. The inversion method may address an ill-posed nature of an inverse problem through techniques that reduce ambiguity of the fracture parameters. The inversion method may be implemented post-job, batched post-job, or real-time.

The inversion method may include a global orientation search over a discrete grid of orientation parameters with time-integrated misfit minimization. The inversion method may also or instead include a multi-seed clustering workflow. The optimization results may be grouped using Hausdorff distance between fracture rectangles. The inversion method may also or instead include a sequential Bayesian particle filter. A particle ensemble represents a fracture state including lengths, widths, height, orientation angles, and stimulation efficiency, with log-space weight updates and systematic resampling upon degeneracy. The inversion method may also or instead include a joint spatio-temporal gradient descent, wherein the fracture parameters across multiple time steps may be optimized simultaneously subject to temporal smoothness and PKN-scaling regularization penalties.

The method 500 may also include estimating an orientation and/or dimensions of the hydraulic fracture 612 based upon the fracture parameters, as at 550. The orientation and/or dimensions may be estimated with quantified uncertainty metrics. The orientation may be estimated by (1) defining a ray of normal direction to a plane of the hydraulic fracture 612; (2) spotting a point on a celestial sphere intersected by the normal direction; (3) determining a longitude and a latitude of the normal direction; and (4) rotating the hydraulic fracture 612 around the normal direction by the twist angle.

The method 500 may also include generating an image showing the orientation and/or dimensions of the hydraulic fracture 612, as at 560. The display may include well trajectories (e.g., treatment well, monitoring well), fracture initiation locations (e.g., perforations, sleeves, etc.), DAS waterfall plot, potential ‘frac hit’ location based on whatever anticipated fly time, etc.

The method 500 may also include performing an action based upon and/or in response to the orientation and/or dimensions, as at 570. The action may include generating and/or transmitting a signal that recommends, instructs, or causes a physical action to occur. The action may also or instead include performing the physical action. In an example, the physical action may include adjusting a pumping schedule of the 620 or halting injection of the slurry 620 in response to the orientation indicating a trajectory toward an adjacent wellbore. Adjusting the pumping schedule may include changing the pressure, the rate, the concentration, and/or changing a chemical diverter. In another example, the physical action may include modifying the concentration of the proppant or stage spacing in response to the dimensions exceeding a predefined threshold.

Examples in the present disclosure may also be directed to a non-transitory computer-readable medium storing computer-executable instructions and executable by one or more processors of the computer via which the computer-readable medium is accessed. A computer-readable media may be any available media that may be accessed by a computer. By way of example, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Note also that the software implemented aspects of the subject matter claimed below are usually encoded on some form of program storage medium or implemented over some type of transmission medium. The program storage medium is a non-transitory medium and may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The claimed subject matter is not limited by these aspects of any given implementation.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific examples are presented for purposes of illustration and description. They are not intended to be exhaustive of or to limit this disclosure to the precise forms described. Obviously, many modifications and variations are possible in view of the above teachings. The examples are shown and described in order to best explain the principles of this disclosure and practical applications, to thereby enable others skilled in the art to best utilize this disclosure and various examples with various modifications as are suited to the particular use contemplated. It is intended that the scope of this disclosure be defined by the claims and their equivalents below.

What is claimed is:

1. A method for characterizing a hydraulic fracture, comprising:
acquiring surface data;
acquiring downhole data;
formulating a model based upon the surface data and the downhole data to predict strain field propagation in a subsurface which contains the hydraulic fracture; and
implementing an inversion method using the model to determine fracture parameters of the hydraulic fracture.

2. The method of claim 1, wherein the surface data and the downhole data are acquired during a hydraulic fracturing operation that is performed to produce the hydraulic fracture in the subsurface.

3. The method of claim 1, wherein the surface data is related to a slurry that is pumped into a well in the subsurface, and wherein the surface data includes a pressure of the slurry, a rate of slurry, and/or a concentration of a proppant in the slurry.

4. The method of claim 1, wherein the downhole data comprises distributed acoustic sensing (DAS) data.

5. The method of claim 4, wherein the DAS data includes strain data acquired from a fiber optic cable.

6. The method of claim 5, wherein the strain data has a frequency less than a low frequency threshold.

7. The method of claim 5, wherein the fiber optic cable is pumped into a well, coupled to a tubing in the well, or cemented behind a casing in the well, and wherein the well is a monitoring well or a treating well.

8. The method of claim 1, wherein the fracture parameters comprise a height of the hydraulic fracture, a length of the hydraulic fracture, a width of the hydraulic fracture, a longitude of the hydraulic fracture, a latitude of the hydraulic fracture, a twist angle of the hydraulic fracture, and/or a stimulation efficiency.

9. The method of claim 1, further comprising estimating an orientation and/or dimensions of the hydraulic fracture based upon the fracture parameters.

10. The method of claim 9, further comprising performing an action based upon and/or in response to the orientation and/or dimensions.

11. A computing system, comprising:
one or more processors; and
a memory system comprising one or more non-transitory computer-readable media storing instructions that, when executed by at least one of the one or more processors, cause the computing system to perform operations, the operations comprising:
acquiring surface data during a hydraulic fracturing operation that is performed to produce a hydraulic fracture in a subsurface, wherein the surface data is related to a slurry that is pumped into a well in the subsurface, and wherein the surface data includes a pressure of the slurry, a rate of slurry, and/or a concentration of a proppant in the slurry;
acquiring downhole data during the hydraulic fracturing operation, wherein the downhole data comprises distributed acoustic sensing (DAS) data, and wherein the DAS data includes strain data acquired from a fiber optic cable in a well;
formulating a model based upon the surface data and the downhole data to predict strain field propagation in the subsurface which contains the hydraulic fracture;
implementing an inversion method using the model to determine fracture parameters of the hydraulic fracture, wherein the model implements the inversion method by comparing the surface data, the downhole data, and the strain field propagation, and wherein the fracture parameters comprise a height of the hydraulic fracture, a length of the hydraulic fracture, a width of the hydraulic fracture, a longitude of the hydraulic fracture, a latitude of the hydraulic fracture, a twist angle of the hydraulic fracture, and/or a stimulation efficiency; and
estimating an orientation and/or dimensions of the hydraulic fracture based upon the fracture parameters.

12. The computing system of claim 11, wherein the model incorporates linear elastic fracture mechanics governing equations.

13. The computing system of claim 11, wherein the model incorporates a poroelastic effect quantification within reservoir media.

14. The computing system of claim 11, wherein the model incorporates fluid flow dynamics characterization within the network.

15. The computing system of claim 11, wherein the model incorporates coupling mechanisms between fracture propagation and rock deformation phenomena.

16. A non-transitory computer-readable medium storing instructions that, when executed by one or more processors of a computing system, cause the computing system to perform operations, the operations comprising:
acquiring surface data during a hydraulic fracturing operation that is performed to produce a hydraulic fracture in a subsurface, wherein the surface data is related to a slurry that is pumped into a well in the subsurface, and wherein the surface data includes a pressure of the slurry, a rate of slurry, and a concentration of a proppant in the slurry;
acquiring downhole data during the hydraulic fracturing operation, wherein the downhole data comprises distributed acoustic sensing (DAS) data, wherein the DAS data includes strain data acquired from a fiber optic cable, wherein the strain data has a frequency less than 10 hertz, wherein the fiber optic cable is pumped into the well, coupled to a tubing in the well, or cemented behind a casing in the well, and wherein the well is a monitoring well or a treating well;
formulating a model based upon the surface data and the downhole data to predict strain field propagation in the subsurface which contains the hydraulic fracture, and wherein the hydraulic fracture is part of a network of natural fractures, hydraulically-induced fractures, and/or reactivated fractures;
implementing an inversion method using the model to determine fracture parameters of the hydraulic fracture, wherein the model implements the inversion method by comparing the surface data, the downhole data, and the strain field propagation, and wherein the fracture parameters comprise a height of the hydraulic fracture, a length of the hydraulic fracture, a width of the hydraulic fracture, a longitude of the hydraulic fracture, a latitude of the hydraulic fracture, a twist angle of the hydraulic fracture, and a stimulation efficiency;
estimating an orientation and/or dimensions of the hydraulic fracture based upon the fracture parameters, wherein the orientation and/or dimensions are estimated with quantified uncertainty metrics; and
performing an action based upon and/or in response to the orientation and/or dimensions, wherein the action comprises generating and/or transmitting a signal that recommends, instructs, or causes a physical action to occur related to the slurry.

17. The non-transitory computer-readable medium of claim 16, wherein the orientation is estimated by:
defining a ray of normal direction to a plane of the hydraulic fracture;
spotting a point on a celestial sphere intersected by the normal direction;
determining a longitude and a latitude of the normal direction; and
rotating the hydraulic fracture around the normal direction by the twist angle.

18. The non-transitory computer-readable medium of claim 16, wherein the physical action comprises modifying the concentration of the proppant or stage spacing in response to the dimensions exceeding a predefined threshold.

19. The non-transitory computer-readable medium of claim 16, wherein the physical action comprises adjusting a pumping schedule of the slurry or halting injection of the slurry in response to the orientation indicating a trajectory toward an adjacent well.

20. The non-transitory computer-readable medium of claim 19, wherein adjusting the pumping schedule comprises changing the pressure, the rate, the concentration, and/or changing a chemical diverter.
